(19) United States
(12) Patent Application Publication
(10) Pub. No.: US 2003/0232170 A1
(43) Pub. Date: Dec. 18, 2003

(54) Spunlaced loop material for a refastenable fastening device and methods of making same

(76) Inventors: Samuel Mark Gillette, Burlington, NC (US); James William Flippin, Greensboro, NC (US); Walter Gomer Jones, Greensboro, NC (US); Zareh Mikaelian, Greensboro, NC (US); Alfred Frank Baldwin JR., Greensboro, NC (US)

Correspondence Address: MYERS BIGEL SIBLEY & SAJOVEC, PO BOX 37428, RALEIGH, NC, 27627, US

(21) Appl. No.: 10/266,917

(22) Filed: Oct. 8, 2002

Related U.S. Application Data
(60) Provisional application No. 60/388,397, filed on Jun. 12, 2002.

(51) Int. Cl. B32B 5/26; B32B 3/02; D04H 1/00

(52) U.S. Cl. 428/92; 442/408; 442/341; 428/156; 442/394; 442/381; 428/196

(57) ABSTRACT

A loop component for use in a hook and loop fastening system, and methods of making same are provided, wherein a spunlaced fabric having a plurality of loop structures is formed by entangling a plurality of non-interbonded fibers in a fibrous web of material. The loop structures are configured to engage hooks from a hook component having a hook density between about 30 and 400 hooks per square centimeter, and have a peel strength of between about 50 grams and 2000 grams. The spunlaced fabric may include a backing layer.

### RELATED APPLICATION

This application claims the benefit of U.S. Provisional Application No. 60/388,397, filed Jun. 12, 2002, the disclosure of which is incorporated herein by reference in its entirety as if set forth fully herein.

### FIELD OF THE INVENTION

The present invention relates generally to fastening systems and, in particular, to loop material for hook and loop fastening systems.

### BACKGROUND OF THE INVENTION

Hook and loop fastening systems are becoming prevalent in many durable and nondurable applications and are replacing other fastening devices such as tape, buckles, zippers and snaps. In general, hook and loop fastening systems include a male hook member, having a plurality of upstanding hook engaging elements, and a female loop member having a plurality of loops in which the hook members become ensnarled to effect fastening engagement of the two components.

Unfortunately, many of the hook and loop fastening systems available today can be difficult to manufacture or can have other drawbacks which may limit their utility. For example, woven and knit fabrics may require complex equipment and multiple processes in order to construct a loop material. Conventional nonwoven loop systems require inter-fiber bonding to reduce fiber spreading and accommodate hooks from a hook component. (e.g., see U.S. Pat. No. 5,326,612 to Goulait). Moreover, conventional loop member material may not be soft enough for personal hygiene applications, such as disposable diapers, surgical gowns, sanitary napkins, etc.

### SUMMARY OF THE INVENTION

Applicants have discovered that spunlaced fabric having non-interbonded fibers (i.e., fibers not bonded to other fibers) can be produced that will engage hooks of hook and loop fastening systems with acceptable peel strength, as described in ASTM D-5170-98. A spunlaced fabric is a fabric which has been formed by impinging a web (which can include preformed fabrics, spunmelt webs, air laid webs and carded webs) with jets of high pressure water. Spunlaced fabrics have conventionally not been expected to offer any utility in the design of a loop material for a hook and loop fastening system. This is because the consolidation of fibers via water jets has been considered unsuitable for forming loops for use in hook and loop fastening systems. However, Applicants have unexpectedly discovered that a loop structure conducive to penetration and engagement by hook members can be created from spunlaced fabrics.

According to embodiments of the present invention, a method of forming a loop component for use in a hook and loop fastening system includes forming a spunlaced fabric having loop structures with no inter-fiber bonds, and bonding the spunlaced fabric to a backing layer to produce a loop component. Loop components according to embodiments of the present invention can have loop structures configured to engage hooks from a hook component having a hook density between about 30 and 400 hooks per square centimeter. Loop structures according to embodiments of the present invention can have a peel strength of between about 50 grams and 2000 grams, and can have a shear strength of between about 1,000 and 15,000 grams.

Embodiments of the present invention can provide aesthetically pleasing hook and loop fastening systems. Spunlaced loop member materials according to embodiments of the present invention are superior to conventional loop member materials because of the visual consistency and soft hand obtained. Moreover, loop members according to embodiments of the present invention have utility in a broad range of applications, particularly personal hygiene applications, such as disposable diapers, surgical gowns, sanitary napkins, etc.

### BRIEF DESCRIPTION OF THE DRAWINGS

The accompanying drawings, which form a part of the specification, illustrate embodiments of the present invention. The drawings and description together serve to fully explain the invention.

FIG. 1 is a flow diagram that illustrates methods of forming a loop component for use in a hook and loop fastening system, according to embodiments of the present invention.

FIG. 2 is a flow diagram that illustrates operations for forming a spunlaced fabric having loop structures with no inter-fiber bonds, according to embodiments of the present invention.

FIGS. 3A-3V illustrate examples of bonding patterns that may be utilized according to embodiments of the present invention.

FIG. 3W illustrates an exemplary print pattern that may be utilized according to embodiments of the present invention.

### DETAILED DESCRIPTION OF THE INVENTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

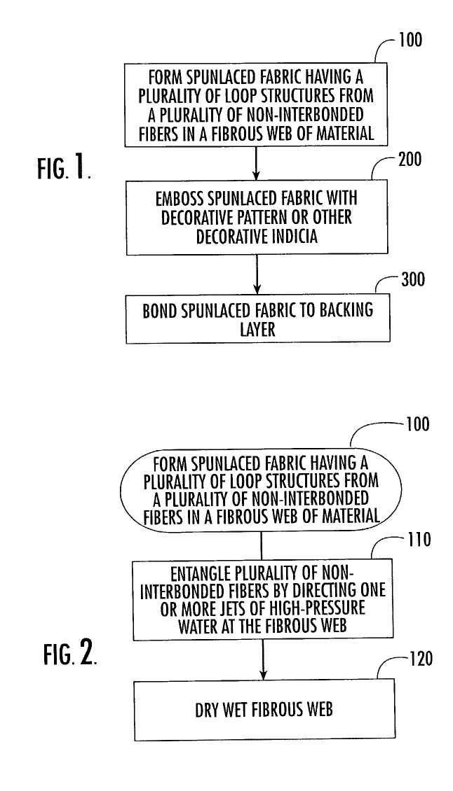

Referring now to FIG. 1, a method of forming a loop component for use in a hook and loop fastening system, according to embodiments of the present invention, includes forming a spunlaced fabric having a plurality of loop structures from a plurality of non-interbonded fibers (i.e., fibers not bonded to other fibers) in a fibrous web of material (Block 100), optionally embossing the spunlaced fabric with a decorative pattern or other decorative indicia (Block 200), and optionally bonding the spunlaced fabric to a backing layer (Block 300).

A loop component according to embodiments of the present invention can have loop structures configured to engage hooks from a hook component having a hook density between about 30 and 400 hooks per square centimeter. The loop structures can have a peel strength of between about 50 grams and 2000 grams (preferably 300700 grams) using ASTM D5170-98, and can have peak shears of between about 1,000 and 15,000 grams (preferably 1,800-9,000 grams) using ASTM D5169-91.

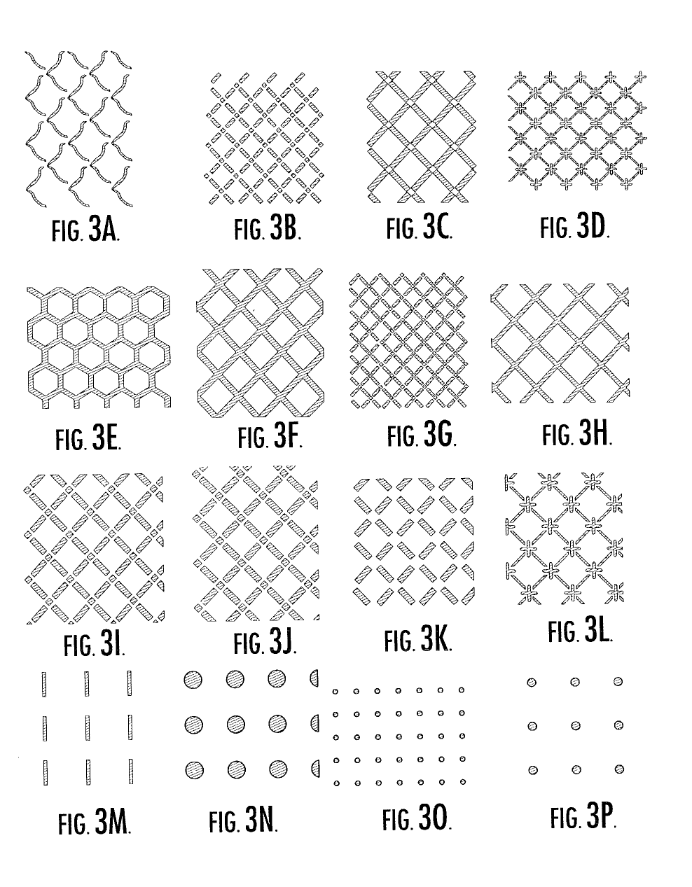

FIG. 2 illustrates operations for forming a spunlaced fabric having loop structures with no inter-fiber bonds. Non-interbonded fibers in a fibrous web of material are entangled to form a plurality of loop structures by directing one or more jets of high-pressure water at the fibrous web of material (Block 110). The fibrous web may contain randomly oriented fibers or substantially aligned fibers. Exemplary fibers include, but are not limited to, polypropylene, polyethylene, polyethylene terephthalate, polyester, acetate, nylon, viscose and acrylic, and blends thereof. Bicomponent fibers of such polymers may also be used. Exemplary fibrous webs include preformed fabrics, spunmelt webs, air laid webs, carded webs, etc. The spunlaced fabric may be homogenous according to embodiments of the present invention.

Fibers within spunlaced fabrics, according to embodiments of the present invention, preferably have a denier of between about 0.5 and 19, and a density of between about 0.1 and 1.2 grams per cubic centimeter. However, embodiments of the present invention are not limited to fibers having this denier range or this density range. A spunlaced fabric according to embodiments of the present invention preferably has a thickness of between about 10 and 95 mils. However, embodiments of the present invention are not limited to spunlaced fabrics having this thickness range.

Well distributed and entangled fibers impart strength, consistency (visual coverage, uniform thickness and basis weight uniformity), smoothness and softness to spunlaced fabrics. The degree of fiber entanglement provided by water jet impingement can control the degree to which the fabric fuzzes after repeated peels from a hook member.

According to embodiments of the present invention, a batt of fibrous material may be formed above and below a spunbonded fabric or net. Fibers from the three layers may then be entangled via water jets (hydroentangling) to produce a spunlaced fabric.

The wet fibrous web of material may then be dried, for example using a vacuum box and a dryer (Block 120). If a finish and/or color is to be added to the spunlace fabric, a padder may be utilized, as is known to those skilled in the art. Another dryer immediately following the padder to dry the fibrous web may also be utilized. Additionally, the web can be apertured during the process.

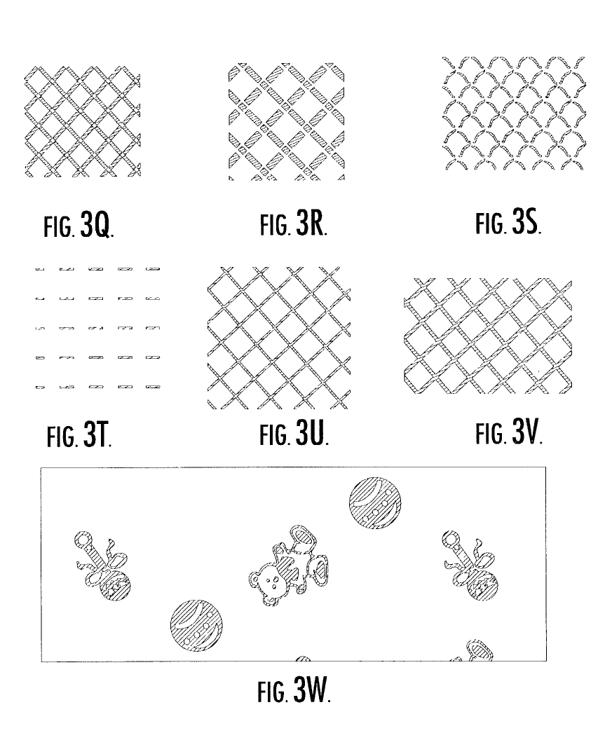

The optional step of embossing a spunlaced fabric with a decorative pattern or other decorative indicia (Block 200) may provide additional dimensional stability to the spunlaced fabric. FIG. 3W illustrates an exemplary decorative pattern that may be embossed and/or printed. Various decorative patterns may be utilized, however, without limitation. Embossing may be performed in various ways including, but not limited to, via thermal energy, ultrasonic energy, and/or heat and pressure. Preferably, the elements of the design have a pattern that has dimensions between about 0.02 mm to 4.0 mm, and the repeat unit is about 0.2 cm to 12.0 cm.

An optional backing layer may provide additional dimensional stability, and may increase the durability of the structure to hook release forces and repeat engagements. A backing layer can also provide aesthetics by having various types of decorative indicia and/or colors. A backing layer may also help reduce “fuzzing” of a spunlaced fabric after repeated “peels” from a hook member, and may help reduce fiber “pull-out” from the spunlaced fabric.

Bonding the spunlaced fabric to a backing layer to produce a loop component (Block 300) may include bonding the spunlaced fabric to various types of materials. A composite backing layer and spunlaced fabric according to embodiments of the present invention may have a MD (machine direction) grab tensile strength of between about 10 pounds and 40 pounds. Moreover, a composite backing layer and spunlaced fabric according to embodiments of the present invention may have a Frazier air permeability of less than about 25 cubic feet per minute.

Bonding may be performed in one or more patterns. Bonding may be done using thermal or ultrasonic processes, autogenously, or may be attached using an adhesive, or using combinations of such techniques. The term “autogenously” means that the spunlaced fabric is secured to a backing layer without the aid of a third material. For example, spunlaced fabric can be fused or melted into a backing layer, and, can be done so in a pattern. The bond area may be between about 2.5% and 25% of the surface area of the backing layer. FIGS. 3A-3V illustrate various bond patterns that may be utilized in accordance with embodiments of the present invention. However, it is understood that other bond patterns may also be utilized.

A backing layer may be a film, nonwoven fabric, lightweight woven fabric, or knit scrim. If the backing layer is a film it may be produced from a polymer such as polypropylene, polyester, polyolefin, polyvinyl alcohol, block copolymer, elastomeric polymer, copolyester, copolyether ester, urethane, styrene block copolymer, elastic foam, polyvinyl chloride, copolyether amide such as Pebax®, or combinations thereof. The most preferred polymer is a low-density polyethylene. Optionally, the film can be impervious to water. Film thickness may range from about 0.00025 inches to about 0.010 inches, with the most preferred range being from about 0.0006 inches to about 0.002 inches. The density of a backing layer film may be between about 0.65 grams per cubic centimeter and about 1.4 grams per cubic centimeter. Corona treatment of a backing layer film is optional for embodiments of the present invention.

For fabric backing layers, all of the nonwoven technologies such as spunbonded, thermal bonded, resin bonded, needle punched, stitch bonded, flash spun, spunlaced, wet-laid, thru-air bonded, and others known to those skilled in the art, would be appropriate. Paper, woven fabric, and knitted fabric could also be used.

Optionally, a fabric backing layer may be printed with a pattern, characters, and or other decorative indicia. A printed pattern and/or indicia may be used in addition to a pattern used in bonding.

Backing layers according to embodiments of the present invention preferably have a thickness of between about 0.4 and 40 mils, and a density of between about 0.65 and 1.4 grams per cubic centimeter. However, embodiments of the present invention are not limited to backing layers having this thickness range or this density range.

Hook and loop fastening systems according to embodiments of the present invention can be used as material for disposable diapers and other garments, and can be attached to the waist portion of disposable diapers and other garments utilizing techniques known to those skilled in the art. For example, embodiments of the present invention can be used as the waist band of a disposable diaper or other garment.

According to embodiments of the present invention, a hook and loop fastening system is provided that utilizes a female loop component as described above in conjunction with a male hook component of virtually any type. Preferably, a loop component has loop structures configured to engage hooks from a hook component having a hook density between about 30 and 400 hooks per square centimeter. Preferably, the loop structures have a peel strength of between about 50 grams and 2000 grams using ASTM D5170-98, and have peak shears of between about 1,000 and 15,000 grams using ASTM D5169-91. Exemplary hook components are available, for example, from Bender. Hook components may be formed from fibers of a wide range of materials. Suitable materials include, but are not limited to nylon, polyester, polypropylene, or any combination of these or other materials.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A loop component for use in a hook and loop fastening system, comprising a spunlaced fabric having a plurality of loop structures formed by entangling a plurality of non-interbonded fibers in a fibrous web of material.

2. The loop component of claim 1, wherein the loop structures of the spunlaced fabric are configured to engage hooks from a hook component having a hook density between about 30 and 400 hooks per square centimeter.

3. The loop component of claim 1, wherein the loop structures of the spunlaced fabric are configured to engage hooks from a hook component having individual hook lengths of 0.8 cm or less.

4. The loop component of claim 1, wherein the loop structures of the spunlaced fabric have an average peel strength of between about 50 grams and 550 grams when tested using ASTM D5170-98 test method.

5. The loop component of claim 1, wherein the loop structures of the spunlaced fabric have an average maximum load peel strength of between about 100 grams and 2,000 grams when tested using ASTM D5170-98 test method.

6. The loop component of claim 1, wherein the loop structures of the spunlaced fabric have an average peak shear strength of between about 1,000 and 15,000 grams when tested using ASTM D5169-91 test method.

7. The loop component of claim 1, wherein the loop structures of the spunlaced fabric maintain a maximum average peel strength after 20 test cycles between about 50 and 550 grams when tested using ASTM D5170-98 test method.

8. The loop component of claim 1, wherein the fibers of the spunlaced fabric have a denier of between about 0.5 and 19.

9. The loop component of claim 1, wherein the fibers of the spunlaced fabric have a density of between about 0.1 and 1.2 grams per cubic centimeter.

10. The loop component of claim 1, wherein the spunlaced fabric has a thickness of between about 10 and 95 mils.

11. The loop component of claim 1, wherein the non-interbonded fibers of the fibrous web comprise fibers selected from the group consisting of polypropylene, polyethylene, polyethylene terephthalate, polyester, acetate, nylon, viscose and acrylic, or blends or bicomponents thereof.

12. The loop component of claim 1, wherein the spunlaced fabric comprises homogenous spunlaced fabric.

13. The loop component of claim 1, wherein the spunlaced fabric comprises randomly oriented fibers.

14. The loop component of claim 1, wherein the spunlaced fabric comprises substantially aligned fibers.

15. The loop component of claim 1, wherein the spunlaced fabric comprises apertured spunlaced fabric.

16. The loop component of claim 1, wherein the spunlaced fabric comprises two or more layers of fibrous material.

17. The loop component of claim 1, wherein the spunlaced fabric is formed from a fibrous web via air laying.

18. The loop component of claim 1, wherein the spunlaced fabric is formed from a fibrous web via carding.

19. The loop component of claim 1, wherein the spunlaced fabric is embossed with a decorative pattern.

20. The loop component of claim 19, wherein the decorative pattern comprises elements having dimensions between about 0.02 mm and 4 mm.

21. The loop component of claim 1, further comprising a backing layer bonded to the spunlaced fabric.

22. The loop component of claim 21, wherein the backing layer comprises material selected from the group consisting of polypropylene, polyethylene, polyester, acetate, nylon, urethane, or blends thereof.

23. The loop component of claim 21, wherein the backing layer comprises material selected from the group consisting of polymer film, nonwoven fabric, woven fabric, and knit scrim.

24. The loop component of claim 21, wherein the backing layer comprises polyolefin film having a density less than about 0.91 grams per cubic centimeter.

25. The loop component of claim 21, wherein the backing layer is bonded to the spunlaced fabric either thermally, adhesively, autogenously, or ultrasonically.

26. The loop component of claim 21, wherein the backing layer is autogenously bonded to the spunlaced fabric in a pattern.

27. The loop component of claim 26, wherein the bond pattern comprises a continuous bond pattern.

28. The loop component of claim 26, wherein the bond pattern comprises a repeat unit of between about 0.2 cm and 12 cm.

29. The loop component of claim 26, wherein the bond pattern comprises elements having dimensions between about 0.02 mm and 4 mm.

30. The loop component of claim 21, wherein the spunlaced fabric is bonded to between about 2.5% and 25% of a surface area of the backing layer.

31. The loop component of claim 21, wherein the backing layer comprises decorative indicia and/or coloring.

32. The loop component of claim 21, wherein the backing layer comprises material impervious to water.

33. The loop component of claim 21, wherein the backing layer comprises material configured to reduce a tendency of the spunlaced fabric to elongate.

34. The loop component of claim 21, wherein the backing layer comprises material configured to reduce a tendency of the spunlaced fabric to fuzz and to reduce a tendency of fibers to pull out from the spunlaced fabric.

35. The loop component of claim 21, wherein the backing layer comprises material configured to change air permeability of the spunlaced fabric and backing layer.

36. The loop component of claim 21, wherein the backing layer has a thickness between about 0.4 and 40 mils.

37. The loop component of claim 21, wherein the backing layer has a density of between about 0.65 and 1.4 grams per cubic centimeter.

38. The loop component of claim 21, wherein the spunlaced fabric and backing layer has a thickness between about 8 mils and 400 mils.

39. The loop component of claim 21, wherein the spunlaced fabric and backing layer has a basis weight greater than or equal to 19 grams per square meter.

40. The loop component of claim 21, wherein the spunlaced fabric and backing layer has a Frazier air permeability of less than about 25 cubic feet per minute.

41. The loop component of claim 21, wherein the spunlaced fabric and backing layer has a MD grab tensile strength of between about 10 pounds and 40 pounds.

42. A method of forming a loop component for use in a hook and loop fastening system, comprising entangling a plurality of non-interbonded fibers in a fibrous web of material to form a spunlaced fabric having a plurality of loop structures that are configured to engage hooks from a hook component.

43. The method of claim 42, wherein entangling a plurality of non-interbonded fibers comprises directing one or more jets of high-pressure water at the fibrous web of material.

44. The method of claim 42, further comprising bonding the spunlaced fabric to a backing layer.

45. The method of claim 44, wherein bonding comprises thermally, adhesively, or ultrasonically bonding the spunlaced fabric to the backing layer.

46. The method of claim 44, wherein bonding comprises autogenously bonding the spunlaced fabric to the backing layer in a pattern.

47. The method of claim 46, wherein the bond pattern comprises a continuous bond pattern.

48. The method of claim 46, wherein the bond pattern comprises a repeat unit of between about 0.2 cm and 12 cm.

49. The method of claim 47, wherein the bond pattern comprises elements having dimensions between about 0.02 mm and 4 mm.

50. The method of claim 46, wherein the spunlaced fabric is bonded to between about 2.5% and 25% of a surface area of the backing layer.

51. The method of claim 44, further comprising providing the backing layer with decorative indicia and/or coloring.

52. The method of claim 42, further comprising embossing the spunlaced fabric with a decorative pattern.

53. A hook and loop fastening system, comprising:
a hook component having a hook density between about 30 and 400 hooks per square centimeter; and
a loop component, comprising a spunlaced fabric having a plurality of loop structures formed by entangling a plurality of non-interbonded fibers in a fibrous web of material, wherein the loop structures of the spunlaced fabric are configured to engage hooks from the hook component.

54. The hook and loop fastening system of claim 53, wherein the loop structures of the spunlaced fabric are configured to engage hooks having individual hook lengths of 0.8 cm or less.

55. The hook and loop fastening system of claim 53, wherein the loop structures of the spunlaced fabric have an average peel strength of between about 50 grams and 550 grams when tested using ASTM D5170-98 test method.
